(19) United States
(12) Patent Application Publication
(10) Pub. No.: US 2026/0117115 A1
(43) Pub. Date: Apr. 30, 2026

(54) CORROSION INHIBITOR COMPOSITION AND METHOD FOR INHIBITING CORROSION IN GEOTHERMAL WELL SYSTEM

(71) Applicant: CHEMTREAT, INC., Glen Allen, VA (US)

(72) Inventor: Patrick WOOD, Midlothian, VA (US)

(73) Assignee: CHEMTREAT, INC., Glen Allen, VA (US)

(21) Appl. No.: 19/365,737

(22) Filed: Oct. 22, 2025

Related U.S. Application Data
(60) Provisional application No. 63/711,386, filed on Oct. 24, 2024.

(51) Int. Cl. C09K 8/54; C09D 5/08; C09D 7/45; C09D 7/63; C23F 11/12; C23F 11/14; C23F 11/167; E21B 41/02; F03G 4/00

(52) U.S. Cl. CPC C09K 8/54; C09D 5/086; C09D 7/45; C09D 7/63; C23F 11/126; C23F 11/142; C23F 11/144; C23F 11/145; C23F 11/149; C23F 11/1673; E21B 41/02; C09K 2208/32; F03G 4/069

(57) ABSTRACT

A method for inhibiting corrosion of a corrodible metal surface that contacts a water stream in a geothermal well system. The method includes introducing into the water stream a corrosion inhibitor composition comprising: (i) a cationic surfactant, such as an imidazoline and/or a fatty amine ethoxylate, and (ii) an anionic surfactant.

### CROSS-REFERENCE TO RELATED APPLICATION(S)

This application claims the benefit of U.S. Provisional Application No. 63/711,386, filed Oct. 24, 2024. The disclosure of the prior application is hereby incorporated by reference herein in its entirety.

### TECHNICAL FIELD

This application generally relates to cationic surfactants and anionic surfactants and their use as corrosion inhibitors to inhibit corrosion in geothermal well systems.

### BACKGROUND

Geothermal wells use high pressure and high temperature steam to generate power. In a geothermal well system, fluid is injected into a subterranean system, and is heated by the formation. The high temperature fluid is then pumped to the surface, and may be used for generating electricity, evaporation, heat exchange, or to circulate heat to nearby buildings.

In geothermal operations, metal surfaces, which are composed of ferrous metals, such as mild steel, carbon steel, and the like, are contacted with geothermal fluids, such as brine and steam at elevated temperatures. The brine and steam can include corrosive agents, such as CO₂, O₂, and H₂S gases, which cause corrosion resulting in loss of metal, surface pitting, and embrittlement.

Geothermal operations are carried out at higher temperatures than oil and gas operations, and the elevated temperatures can further promote high corrosion rates in geothermal applications. For example, the temperature in a geothermal well system may be in a range of 150° C. to 500° C., whereas oil and gas operations typically fall within the range of 60° C. to 120° C. Corrosion inhibitors, such as phosphate esters, are often not stable at the high temperatures of geothermal well systems. Other corrosion inhibitors, such as fatty acids, for example dimer or trimer acids and oleic or stearic acid, are typically not soluble in aqueous formulations that are needed for geothermal applications.

There is a need for a corrosion inhibitor composition that is stable at elevated temperatures and effective at mitigating corrosion in geothermal well systems.

### SUMMARY

Disclosed herein is a method for inhibiting corrosion of a corrodible metal surface that contacts a water stream in a geothermal well system. The method includes introducing into the water stream a corrosion inhibitor composition comprising: (i) a cationic surfactant, such as an imidazoline and/or a fatty amine ethoxylate, and (ii) an anionic surfactant.

### BRIEF DESCRIPTION OF THE DRAWINGS

FIG. 1 is a graph showing the corrosion rate over time in low calcium-produced water.

FIG. 2 is a graph showing the corrosion rate over time in moderate calcium-produced water.

FIG. 3 is a graph showing the corrosion rate over time in high calcium-produced water.

### DETAILED DESCRIPTION OF EMBODIMENTS

In the following description, numerous details are set forth to provide an understanding of the present disclosure. However, it may be understood by those skilled in the art that the compositions and methods of the present disclosure may be practiced without these details and that numerous variations or modifications from the described embodiments may be possible.

The present disclosure provides a corrosion inhibitor composition comprising a cationic surfactant, such as an imidazoline and/or a fatty amine ethoxylate, and an anionic surfactant that can be used to inhibit corrosion in geothermal well systems. The composition can also optionally include a mercaptan, which can further increase the rate of corrosion inhibitor. Also disclosed herein is a method for inhibiting corrosion in a geothermal well system including introducing the corrosion inhibitor composition into a water stream of the geothermal well system.

Among the many advantages of the compositions and methods of the present disclosure, the methods and compositions disclosed herein significantly decrease corrosion (e.g., significantly reduce the rate of corrosion) of metal surfaces in a geothermal well system, including, for example, geothermal wellbores, such as injection and production wells, high temperature aquifers, high temperature formations, and combinations thereof.

The corrosion inhibitor composition forms a protective film on metallic surfaces in the geothermal well system that acts as a hydrophobic barrier between the water and the metal surface to prevent corrosion. For example, the cationic surfactant, such as an imidazoline and/or a fatty amine ethoxylate, can form a monomolecular hydrophobic film or layer on metal surfaces that contact water and/or steam. The addition of an anionic surfactant and optionally a mercaptan can provide a synergistic improvement by forming a stable film on at least parts of surfaces not as prone to filming by fatty imidazolines and/or fatty amine ethoxylates. Thus, the corrosion inhibitor composition can provide more complete coverage of the metal surfaces to prevent attack by corrosive material.

The protective film can act as a barrier against corrosion due to its water-repellant behavior. For instance, the film can protect the metal surface against corrosive agents, such as oxygen, carbon dioxide, and hydrogen sulfide. The corrosion inhibitor composition can keep heat transfer surfaces free from scale and deposits, which can optimize heat transfer rates. The corrosion inhibitor composition can also keep metal surfaces free from scale and deposits, which can improve (e.g., increase) the flow rate of fluid transmitted through the geothermal well system, for example, the flow rate of fluid injected from an injection conduit, to a subterranean production well, and then out a production outlet.

The corrosion inhibitor composition disclosed herein not only provides robust corrosion protection, but offers many other advantages. For example, the corrosion inhibitor composition is temperature stable at high temperatures. Thus, the corrosion inhibitor composition can be compatible for use in the high temperature environments common to geothermal well systems. In particular, the cationic surfactants disclosed herein can be very thermally stable and show good performance with the anionic inhibitors disclosed herein. The cationic and anionic surfactants disclosed herein can be thermally stable throughout the elevated temperatures of geothermal well systems, for example, up to 350° C. or even higher. For example, the cationic and anionic surfactants can be thermally stable throughout the temperature ranges of 150° C. to 500° C., 175° C. to 400° C., and 200° C. to 350° C. Similarly, the mercaptan and other components of the corrosion inhibitor composition can be thermally stable up to 350° C. (or even higher) and throughout the foregoing temperature ranges.

Accordingly, the corrosion inhibitor composition may be effectively used in a geothermal subterranean system. Even at the high temperatures of geothermal well systems, the active components of the corrosion inhibitor composition can react with metallic surfaces (e.g., by adsorbing onto the metal surface to form a protective film) in a controlled manner, allowing geothermal anticorrosion operations to take place at the native temperature of the geothermal subterranean system, for example, without taking special precautions to control the temperature and/or chemical reactivity.

### Corrosion Inhibitor Composition

As discussed above, the corrosion inhibitor composition includes at least (i) a cationic surfactant, such as an imidazoline and/or a fatty amine ethoxylate and (ii) an anionic surfactant that can be used to inhibit corrosion (e.g., significantly reduce the rate of corrosion) in geothermal well systems.

The cationic surfactant can include an imidazoline compound, such as a fatty imidazoline. Imidazoline compounds, such as 2-imidazolines, 3-imidazolines, and 4-imidazolines are a known class of heterocycles formally derived from imidazoles by the reduction of one of the two double bonds. Imidazolines include a five-membered heterocyclic ring, namely a ring with two nitrogen atoms that can adsorb onto metal surfaces. The imidazoline in the present corrosion inhibitor composition further includes a hydrocarbon chain that forms a hydrophobic film on the metal surfaces. The imidazoline can also include an alkyl amine substituent that can help maintain adsorption on steel surfaces.

For example, the imidazoline can include compounds that are derivatives of imidazoline compounds having at least one carboxylic or carboxylate group and at least two nitrogen atoms. The number of the at least one carboxylic or carboxylate group can be in a range of, for example, 1 to 6, 1 to 4, or 2 to 4. The number of the at least two nitrogen atoms can be in a range of, for example, 2 to 6, 2 to 5, or 2 to 4. These compounds may include two nitrogens and at least 1 carboxylate group in the main chain.

The imidazoline can include an imidazoline derived from a diamine, such as ethylene diamine (EDA), diethylene triamine (DETA), aminoethyl ethanolamine (AEEA), or triethylene tetraamine (TETA), and a long chain fatty acid, such as tall oil fatty acid (TOFA). TOFA is defined as a tall oil fatty acid with oleic acid as a major component. TOFA/DETA imidazoline is a water dispersible corrosion inhibitor. TOFA/DETA imidazoline is prepared by reacting tall oil fatty acid (TOFA), a mixture of oleic and linoleic acids, with diethylene triamine (DETA). The ratio of TOFA to DETA may be varied to give different properties. Generally, the more TOFA that is added, the more oil soluble the product is. In the corrosion inhibitor composition, the imidazoline can be, for example, 1:1 TOFA:DETA imidazoline or 2:1 TOFA:DETA imidazoline. The imidazoline can include an imidazolinium salt, such as 1-benzyl-1-(2-hydroxyethyl)-2-tall oil-2-imidazolinium chloride. The imidazoline can also be salted with various acids, such as acetic acid, sulfuric, thioglycolic, and any other suitable acid, which can make the imidazoline more water soluble. The imidazoline can also be ethoxylated. Ethoxylation of imidazoline can also make the imidazoline more water soluble. This can include, for example, 1:1 TOFA:AEEA imidazolines reacted with 2-12, 3-10, or 4-8 moles ethylene oxide (EO).

The corrosion inhibitor composition can include the imidazoline in an amount in a range of 1 wt. % to 30 wt. %, 3 wt. % to 20 wt. %, or 5 wt. % to 15 wt. %, based on a total weight of the corrosion inhibitor composition.

The cationic surfactant can additionally or alternatively include a fatty amine ethoxylate. The fatty amine ethoxylate can be composed of a fatty alkyl group typically created from coconut (coco) or beef tallow or oleic acid. The fatty alkyl group can be a C₁₀-C₂₂ alkyl group, a C₁₂-C₂₀ alkyl group, or a C₁₄-C₁₈ alkyl group. The fatty alkyl group of the fatty amine ethoxylate can form a hydrophobic film on the metal surfaces. The fatty amine ethoxylate can also include an alkyl amine substituent that can help maintain adsorption on steel surfaces. The fatty amine ethoxylate can have a degree of ethoxylation (moles of ethylene oxide (EO)) in a range of 1 to 15, 2 to 12, or 3 to 10. In an embodiment, the fatty amine ethoxylate has a degree of ethoxylation in the range of 2 to 8. For example, the fatty amine ethoxylate can include tallow amine ethoxylate, such as tallow amine (2) ethoxylate (TAM-2), tallow amine (5) ethoxylate (TAM-5), tallow amine (7) ethoxylate (TAM-7), and tallow amine (8) ethoxylate (TAM-8), cocamine ethoxylate, oleyl amine ethoxylate, or any other suitable fatty amine ethoxylate.

The corrosion inhibitor composition can include the fatty amine ethoxylate in an amount in a range of 1 wt. % to 30 wt. %, 3 wt. % to 20 wt. %, or 5 wt. % to 15 wt. %, based on a total weight of the corrosion inhibitor composition.

The cationic surfactants disclosed herein, such as the fatty imidazoline and/or fatty amine ethoxylate, can be very thermally stable and show good performance with the anionic inhibitors disclosed herein.

The composition can further include an anionic surfactant, which can help form a stable film, for example, on parts of the metal surfaces not as prone to filming by the fatty imidazolines and/or the fatty amine ethoxylate. The addition of the anionic surfactant can synergistically improve the corrosion rate. As shown in the Examples, a significant reduction in the corrosion rate can be obtained with a smaller dosage of a corrosion inhibitor composition including both: (i) a cationic surfactant, such as an imidazoline and/or a fatty amine ethoxylate, and (ii) an anionic surfactant as compared to a composition only including a cationic surfactant, such as an imidazoline and/or a fatty amine ethoxylate. The anionic surfactant can include an alkyl ether carboxylate, an acyl sarcosine, amphoteric organic compound, and/or alkyl sulfonates.

The alkyl ether carboxylate can include a linear or branched chain, alkoxylated C₆-C₃₆, C₁₂-C₃₀, or C₁₈-C₂₄ carboxylic acid. The ethoxylate, or EO, portion can be in a range of 1 to 15, 2 to 12, or 3 to 10. In an embodiment, the degree of ethoxylation can be in the range of 2 to 8. The alkyl ether carboxylate can be, for example, laureth-6-carboxylic acid.

The acyl sarcosine can be, for example, one or more of oleoyl sarcosine, cocoyl sarcosine, lauroyl sarcosine, myristoyl sarcosine, and stearoyl sarcosine.

The amphoteric organic compound can be an imidazoline-derived amphoteric organic compound, such as alkyl amphoacetates, alkyl amphopropionates, and/or alkyl iminopropionates. These surfactants are usually produced by the reaction of fatty acids or their esters with amines, for example, aminoethylethanol amine. The amphoteric compound can include, for example, one or more of sodium cocoamphoacetate, disodium cocoamphodiacetate, sodium lauroamphoacetate, disodium lauroamphodiacetate, sodium lauriminodipropionate, disodium lauroamphodipropionate, and the like.

The anionic surfactant can be an alkyl sulfonate, having a sulfonate group (—SO₃) attached to an alkyl group. The alkyl sulfonate can be, for example, one or more of oleyl sulfonic acid, alpha olefin sulfonate, and dodecyl benzene sulfonic acid, or any other suitable alkyl sulfonate.

In an embodiment, the anionic surfactant can be selected from the group of an alkyl ether carboxylate, such as laureth-6-carboxylic acid, oleoyl sarcosine, and sodium cocoamphoacetate.

The corrosion inhibitor composition includes the anionic surfactant in an amount in a range of 1 wt. % to 20 wt. %, based on a total weight of the corrosion inhibitor composition.

The corrosion inhibitor composition can further comprise a mercaptan, which can provide a synergistic improvement by forming a stable film on parts of the surfaces not as prone to filming by the imidazoline and/or the fatty amine ethoxylate. As shown in the Example, the further addition of a mercaptan can synergistically reduce the corrosion rate at a significantly lower dosage than that of an imidazoline composition. For example, a composition further including a mercaptan can reduce the corrosion rate significantly at a dosage that is half, more than half, or a quarter of the dosage needed to reduce the corrosion rate using a composition including only an imidazoline as an active agent.

The mercaptan can include, for example, a mercaptoalkyl alcohol, 2-mercaptoethanol, alkyl thiophosphate, thioglycolic acid, 3,3′-dithiodipropionic acid, sodium thiosulfate, thiourea, L-cysteine, tert-butyl mercaptan, sodium thiosulfate, ammonium thiosulfate, or a combination thereof. In an embodiment, the mercaptan is a mercaptoalkyl alcohol, such as 2-mercaptoethanol, a dialkyl dithiophosphate, such as diethyl dithiophosphate, or is thioglycolic acid. The mercaptan can constitute about 0.5 to about 15 wt. %, about 1 to about 10 wt. %, or about 1 to about 5 wt. % of the corrosion inhibitor composition, based on total weight of the composition.

Any number of additional additives may also be introduced into the water stream as part of the corrosion inhibitor composition or separate from the corrosion inhibitor composition. Examples of such additional additives include, but are not limited to, salts, surfactants, acids, spacers, diverting agents, fluid loss control additives, gas, nitrogen, carbon dioxide, surface modifying agents, gelling agents, foamers, corrosion inhibitors, scale inhibitors, etching agents, catalysts, clay control agents, biocides, friction reducers, antifoam agents, bridging agents, flocculants, additional H₂S scavengers, CO₂ scavengers, oxygen scavengers, lubricants, additional viscosifiers, breakers, weighting agents, relative permeability modifiers, resins, wetting agents, coating enhancement agents, filter cake removal agents, antifreeze agents (e.g., ethylene glycol), and the like. A person skilled in the art, with the benefit of this disclosure, will recognize the types of additives that may be included in the fluids of the present disclosure for a particular application.

The corrosion inhibitor composition can be produced by any suitable method, and can be prepared at a well site or at an offsite location.

### Methods of Inhibiting Corrosion

The corrosion inhibitor composition can be used in a method of inhibiting corrosion of a metal surface that contacts an aqueous fluid, such as water and/or steam, in a geothermal well system. The present disclosure provides methods for inhibiting corrosion of a corrodible metal surface in a geothermal well system. The geothermal system can employ aqueous working fluids to extract geothermal energy from a subterranean system. A working fluid, such as a water stream, can be injected into a geothermal subterranean system through an injection inlet and allowed to heat within the subterranean system. In certain embodiments, the water stream may pass through one or more wellbores and/or fractures (e.g., primary and/or secondary) in a subterranean formation. A subterranean system is a high-temperature, underground system useable for geothermal energy production. For example, the water stream can be injected through an injection conduit to a subterranean production well, where the water stream is heated. The heated water stream is then produced through a production outlet. The produced water stream can include hot water and/or geothermal brine that is pumped to the surface. The pressure may drop as the water rises to the surface, causing it to vaporize into steam. After production, the water vapor or steam can be used to drive one or more turbines for geothermal energy production, e.g., to generate electric power.

Aqueous fluids suitable for use in the methods and systems disclosed herein can include water from any source. For example, such aqueous fluids can comprise fresh water, salt water (for example, water containing one or more salts dissolved therein), brine (for example, saturated salt water), seawater, or any combination thereof. The aqueous fluid can comprise one or more ionic species, such as those formed by salts dissolved in water. For example, seawater and/or produced water may comprise a variety of divalent cationic species dissolved therein. Produced water can include dissolved solids, such as sodium, calcium, potassium, chlorine, silica, sulfate, and bicarbonate.

The calcium concentration in produced water can be in a range of 100 to 40,000 ppm, 500 to 30,000 ppm, or 1,000 to 20,000 ppm. The corrosion inhibitor composition disclosed herein can be effective in inhibiting corrosion in low, moderate, and high calcium produced water, as shown further in the Examples.

In general, the aqueous fluid (e.g., liquid water and/or water vapor/steam) injected into and produced from the geothermal well system is at least 90 wt. % water, at least 95 wt. % water, or at least 99 wt. % water.

A geothermal well system can include an injection well and a production well, each of which has been drilled from the surface to penetrate at least a portion of a subterranean formation. The injection well includes an inlet at the surface, and the production well includes an inlet at the surface. The inlet to the injection well is spaced or separated from the outlet of the production well in a direction extending substantially along the surface. The injection well can be connected to an injection pump for pumping a working fluid, such as an aqueous stream, into the production well. The production well, through which hot fluid (e.g., hot water, brine, and/or steam) is produced, can be coupled to an electricity generator, such as a turbine.

A working fluid, such as a water stream, can be injected into the injection well (e.g., into the inlet and through the injection well to the subterranean formation) and can travel to one or more fractures (e.g., propped fractures) in the subterranean system and/or conductive channels to absorb heat in the rock formation. The working fluid is generally heated to a temperature in a range of about 125° C. to about 500° C., about 150° C. to about 400° C., about 175° C. to about 350° C., or about 200° C. to about 325° C. After being heated, the high-temperature working fluid (e.g., hot water/brine and/or steam) can travel from the propped fractures and/or conductive channels to the production well for production (e.g., through the production well to the production well outlet at the surface). The high-temperature working fluid can then be used to generate electricity. For example, the high-temperature working fluid can be routed through one or more electricity generators, such as turbines, where the effluent fluids discharged from the turbines can pass through a heat exchanger and be recycled to the injection well.

The geothermal well system can be a closed loop system. The closed loop system can include a well that has been drilled from the surface to penetrate at least a portion of a subterranean formation. The well includes an injection inlet at or near the surface. The injection inlet can be coupled to an injection pump for pumping the working fluid from the injection inlet through the well. The well can extend from the injection inlet at the surface in a substantially vertical direction to penetrate the subterranean formation. The well can then extend in a substantially horizontal direction (transverse or substantially orthogonal to the vertical direction) through the subterranean formation.

The well further includes a production outlet at or near the surface at a position separate from or spaced from the injection inlet along a direction of the surface. The production outlet can be coupled to an electricity generator, such as a turbine. The well extends in a substantially vertical direction from the production outlet to penetrate the subterranean formation, and then extends in a substantially horizontal direction through the subterranean formation. The substantially horizontal portions of the well are connected to each other to form a closed loop system. In other words, the well extends from the injection inlet at or near the surface in a substantially vertical direction to a subterranean formation through the substantially horizontal portions in the subterranean formation, and then up in a substantially vertical direction to the production outlet at or near the surface.

A working fluid, such as a water stream, can be injected into the injection inlet of the closed-loop system. The working fluid can be heated as it passes through a region of the closed well that is heated by a hot underground (e.g., subterranean) formation. The working fluid is generally heated to a temperature in a range of about 125° C. to about 500° C., about 150° C. to about 400° C., about 175° C. to about 350° C., or about 200° C. to about 325° C. The heated working fluid (e.g., hot water stream and/or steam) can then be produced via the production outlet. The heated working fluid can be used to generate electricity. For example, the heated working fluid may be routed through one or more electricity generators (e.g., turbines), where the effluent fluids discharged from the turbines can pass through a heat exchanger and be recycled to the injection inlet.

In the present methods, the corrosion inhibitor composition disclosed herein is introduced into the aqueous fluid in the geothermal well system. The corrosion inhibitor composition can be introduced into the water stream in an amount in a range of 0.1 ppm to 40 ppm, 0.5 ppm to 35 ppm, 1 ppm to 30 ppm, 5 pm to 25 ppm, or 10 ppm to 20 ppm. The corrosion inhibitor composition can be introduced into the working fluid (e.g., water stream) injected into the injection inlet of the well. The corrosion inhibitor composition can be introduced into the water stream at the surface and then is pumped into the production well with the water stream. Alternatively, the corrosion inhibitor composition can be introduced into the water stream through a capillary tube that extends from the surface towards the production well. For example, the capillary tube can extend through the injection well to the subterranean production well. Thus, the corrosion inhibitor composition can be injected directly into the production well through the capillary tube.

Produced geothermal water can be corrosive to metallic materials due to its natural chemical components, mainly hydrogen ions, chloride, and sulfate, dissolved gases (CO₂ and H₂S) and because of its high temperature and pressure properties. The corrosion inhibitor composition disclosed herein provides robust corrosion inhibition even in the highly corrosive environment of geothermal well systems. It is believed that the active agents of the corrosion inhibitor composition adsorb onto the metal surfaces to form a protective film on the corrodible metal surfaces of the geothermal well system. The corrosion inhibitor composition can form a stable monomolecular hydrophobic film or layer on metal surfaces that contact water and/or steam. The metal surfaces that are in contact with the aqueous fluids (e.g., water and/or steam) of the geothermal well systems disclosed herein can include ferrous metals such as steel (e.g., mild steel, stainless steel, galvanized steel, etc.), aluminum and its alloys, and yellow metals (e.g., copper and copper-based alloys including bronzes, brasses, etc.). For example, the corrosion inhibitor composition can form a protective film on metal surfaces of any part of the geothermal well system, including, for example, the injection well and the production well, as well as the injection inlet and production outlet. The corrosion inhibitor composition can further form a protective film on the metal surfaces of the above ground equipment that contacts the produced water and steam, such as pumps, heat exchangers, turbines, and the like.

The protective film can act as a barrier against corrosion due to its water-repellant behavior. For instance, the film can protect the metal surface against corrosive agents, such as oxygen, carbon dioxide, and hydrogen sulfide. The corrosion inhibitor composition can keep heat transfer surfaces free from scale and deposits, which can optimize heat transfer rates. The corrosion inhibitor composition can also keep metal surfaces free from scale and deposits, which can improve (e.g., increase) the flow rate of fluid transmitted through the geothermal well system, for example, the flow rate of fluid injected from the injection inlet to the production well, and then out the production outlet.

The corrosion inhibitor composition disclosed herein is temperature stable at high temperatures, making it compatible for use in the high temperature environments common to geothermal well systems. The corrosion inhibitor composition can be thermally stable throughout the elevated temperatures of geothermal well systems, for example, up to 350° C. or even higher, throughout the temperature ranges of 150° C. to 500° C., 175° C. to 450° C., and 200° C. to 400° C. The corrosion inhibitor composition can also be stable at the high pressures of geothermal well systems, for example, at pressures in a range of 250 psi to 600 psi, 300 psi to 550 psi, or 400 psi to 500 psi. Even at the high temperatures and pressures of geothermal well systems, the active components of the corrosion inhibitor composition can adsorb onto the metal surface to form a protective film in a controlled manner to significantly reduce the corrosion rate.

The foregoing is further illustrated by reference to the following examples, which are presented for purposes of illustration and are not intended to limit the scope of the present disclosure.

### EXAMPLES

Several corrosion inhibitor compositions were tested to determine their potential to inhibit corrosion of mild/low carbon steel (C1018 MS) in contact with water in a geothermal well system, as shown in Tables 1-8 below.

TABLE 1
Ref Composition

| | | |
|---|---|---|
| RO Water | 76.07 | wt. % |
| 56% Acetic | 8.93 | wt. % |
| acid | | |
| 1:1 Tall Oil | 10.00 | wt. % |
| Imidazoline | | |
| Isopropanol | 5.00 | wt. % |

TABLE 2
Composition A-1

| | | |
|---|---|---|
| RO Water | 76.00 | wt. % |
| 56% Acetic acid | 4.00 | wt. % |
| 1:1 Tall Oil | 10.00 | wt. % |
| Imidazoline | | |
| Isopropanol | 5.00 | wt. % |
| Laureth-6- | 5.00 | wt. % |
| Carboxylic Acid | | |

TABLE 3
Composition A-2

| | | |
|---|---|---|
| RO Water | 62.87 | wt. % |
| 56% Acetic acid | 8.93 | wt. % |
| 1:1 Tall Oil | 10.00 | wt. % |
| Imidazoline | | |
| Isopropanol | 5.00 | wt. % |
| 38% sodium | 13.20 | wt. % |
| cocoamphoacetate | | |

TABLE 4
Composition A-3

| | | |
|---|---|---|
| RO Water | 66.07 | wt. % |
| 56% Acetic acid | 8.93 | wt. % |
| 1:1 Tall Oil | 7.50 | wt. % |
| Imidazoline | | |
| Isopropanol | 15.00 | wt. % |
| Oleoyl Sarcosine | 2.50 | wt. % |

TABLE 5
Composition B-1

| | | |
|---|---|---|
| RO Water | 73.00 | wt. % |
| 56% Acetic acid | 4.00 | wt. % |
| 1:1 Tall Oil | 10.00 | wt. % |
| Imidazoline | | |
| Isopropanol | 5.00 | wt. % |
| Laureth-6- | 5.00 | wt. % |
| Carboxylic Acid | | |
| Diethyl | 3.00 | wt. % |
| dithiophosphate | | |

TABLE 6
Composition B-2

| | | |
|---|---|---|
| RO Water | 59.87 | wt. % |
| 56% Acetic acid | 8.93 | wt. % |
| 1:1 Tall Oil | 10.00 | wt. % |
| Imidazoline | | |
| Isopropanol | 5.00 | wt. % |
| 38% Sodium | 13.20 | wt. % |
| Cocoamphoacetate | | |
| Diethyl | 3.00 | wt. % |
| dithiophosphate | | |

TABLE 7
Composition B-3

| | | |
|---|---|---|
| RO Water | 69.00 | wt. % |
| 56% Acetic acid | 3.00 | wt. % |
| 1:1 Tall Oil | 7.50 | wt. % |
| Imidazoline | | |
| Isopropanol | 15.00 | wt. % |
| Oleoyl Sarcosine | 2.50 | wt. % |
| Diethyl | 3.00 | wt. % |
| dithiophosphate | | |

TABLE 8
Composition C-1

| | | |
|---|---|---|
| RO Water | 84.30 | wt. % |
| Fatty Amine | 6.60 | wt. % |
| Ethoxylate (TAM-5) | | |
| Oleoyl Sarcosine | 3.40 | wt. % |
| Isopropanol | 5.00 | wt. % |
| RM22 | 0.70 | wt. % |

Samples of low calcium water, moderate calcium water, and high calcium water were prepared. The compositions of the water samples are shown in Tables 9-11 below.

TABLE 9
Low Calcium Water Composition

| | | |
|---|---|---|
| Sodium | 2877 | ppm |
| calcium | 100 | ppm |
| potassium | 200 | ppm |
| chloride | 4732 | ppm |
| Malk | 324 | ppm |

TABLE 10
Moderate Calcium Water Composition

| | | |
|---|---|---|
| Sodium | 4000 | ppm |
| calcium | 750 | ppm |
| potassium | 300 | ppm |
| chloride | 7700 | ppm |
| Malk | 330 | ppm |

TABLE 11
High Calcium Water Composition

| | | |
|---|---|---|
| Sodium | 55000 | ppm |
| calcium | 27000 | ppm |
| potassium | 17000 | ppm |
| chloride | 150000 | ppm |
| Malk | 330 | ppm |

Experiments were conducted using a Rotating Cylinder Electrode (RCE) setup. Steel coupons (C1018 MS) were added to the sample cells containing either low, moderate, or high calcium water, and the cells were continuously stirred at a speed of 500 rpm, and under a partial pressure of carbon dioxide (PCO2) of 14.7 psi over a duration of the testing. The low calcium water samples were heated to a temperature of 65.6° C., and the moderate and high calcium water samples were heated to a temperature of 80° C., and those temperatures were maintained for a duration of the testing.

### Example 1

The cells containing the low calcium water samples were dosed with 40 ppm of the Ref Composition, 20 ppm of Composition A-1, 10 ppm of Composition B-1, or 7.5 ppm of Composition C-1. The corrosion rates (in mpy) of the steel coupons were monitored over a 22 hour period. Corrosion rates were determined by utilizing Linear Polarization Resistance (LPR). LPR sweeps were generated every hour for 22 hours providing instantaneous corrosion rates.

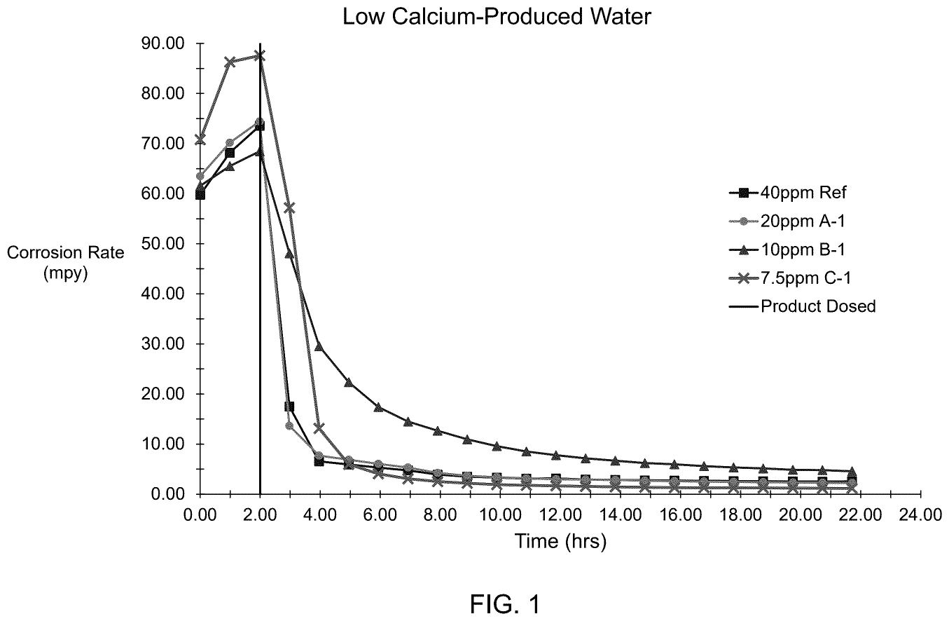

FIG. 1 shows the corrosion rates over the 22 hour period. As shown in FIG. 1, all compositions significantly reduced the corrosion rate over the 22 hour period. Compositions A-1, B-1, and C-1 achieved roughly similar reductions in the corrosion rate as compared to that of the Ref Composition despite the lower dosages of Compositions A-1 (20 ppm), B-1 (10 ppm), and C-1 (7.5 ppm) as compared to the Ref composition (40 ppm). The results show that the addition of an anionic surfactant, such as laureth-6-carboxylic acid, in composition A-1 can synergistically improve the corrosion rate of an imidazoline-based composition (Ref composition) in low calcium produced water. Indeed, practically the same corrosion rate was obtained with composition A-1 at half the dosage (20 ppm) as compared to the Ref Composition (40 ppm). The further addition of a mercaptan (diethyl dithiophosphate) in composition B-1 also synergistically improved corrosion inhibition. Indeed, composition B-1 achieved roughly similar corrosion rates as composition A-1 and the Ref composition at half and a quarter of the dosages of the former (10 ppm). Composition C-3 shows that the combination of an anionic surfactant with a different cationic surfactant, namely a fatty amine ethoxylate, can likewise significantly reduce the corrosion rate. Indeed, composition C-3, at less than a quarter of the dosage of the Ref composition, achieved the lowest corrosion rate over the duration after dosage.

### Example 2

The cells containing the moderate calcium water samples were dosed with 40 ppm of the Ref Composition, 20 ppm of Composition A-1, 20 ppm of Composition A-2, 20 ppm of Composition A-3, 10 ppm of Composition B-3, or 20 ppm of Composition C-1. The corrosion rates (in mpy) of the steel coupons were monitored over a 22 hour period in the same manner as in Example 1.

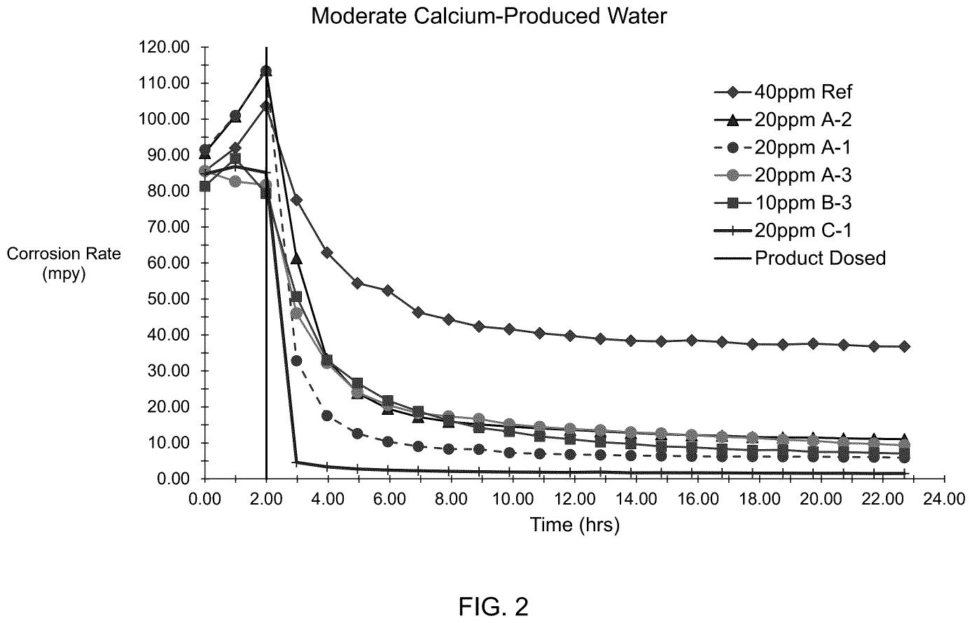

FIG. 2 shows the corrosion rates over the 22 hour period. As shown in FIG. 2, compositions A-1, A-2, A-3, B-3, and C-1 all achieved significantly lower corrosion rates than the Ref composition over 22 hour period despite the lower dosages of Compositions A-1 (20 ppm), A-2 (20 ppm), A-3 (20 ppm), B-3 (10 ppm), and C-1 (20 ppm) as compared to the Ref composition (40 ppm).

The results show that the addition of an anionic surfactant, such as laureth-6-carboxylic acid, sodium cocoamphoacetate, and oleoyl sarcosine, in compositions A-1, A-2, and A-3, respectively, can synergistically improve the corrosion rate of a cationic surfactant-based composition, specifically an imidazoline-based composition (Ref composition) in moderate calcium produced water. Indeed, significantly lower corrosion rates were obtained with compositions A-1, A-2, and A-3 at half the dosage (20 ppm) of the Ref Composition (40 ppm). The further addition of a mercaptan (diethyl dithiophosphate) in composition B-3 further synergistically improved corrosion inhibition. Indeed, composition B-3 achieved a similar corrosion rate as that of compositions A-1, A-2, and A-3 (20 ppm each) at half the dosage of the former (10 ppm). Composition C-3 shows that the combination of an anionic surfactant with a different cationic surfactant, namely a fatty amine ethoxylate, can likewise significantly reduce the corrosion rate. Indeed, composition C-3, at half the dosage of the Ref composition, achieved the lowest corrosion rate over the duration after dosage.

### Example 3

The cells containing the high calcium water samples were dosed with 40 ppm of the Ref Composition, 15 ppm of Composition A-2, 5 ppm of Composition B-2, or 15 ppm of Composition C-1. The corrosion rates (in mpy) of the steel coupons were monitored over a 22 hour period in the same manner as in Example 1.

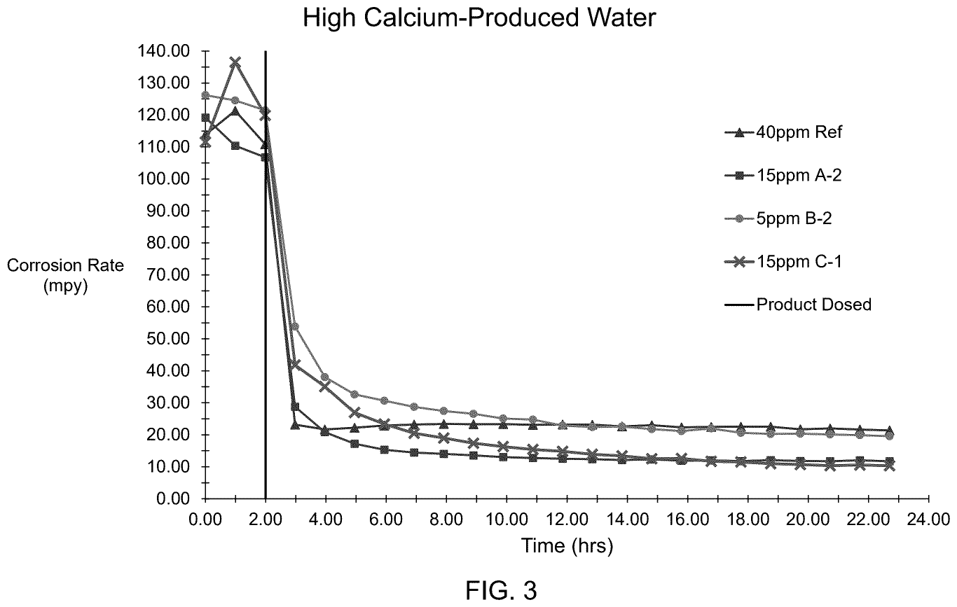

FIG. 3 shows the corrosion rates over the 22 hour period. As shown in FIG. 3, all compositions significantly reduced the corrosion rate over the 22 hour period. Compositions A-2 B-2, and C-1 achieved roughly similar reductions in the corrosion rate as compared to that of the Ref Composition despite the lower dosages of Compositions A-2 (15 ppm) and B-2 (5 ppm) as compared to the Ref composition (40 ppm). The results show that the addition of an anionic surfactant, such as sodium cocoamphoacetate, in composition A-2 can synergistically improve the corrosion rate of an imidazoline-based composition (Ref composition) in high calcium produced water. Indeed, composition A-2, at a dosage (15 ppm) that was less than half the dosage of the Ref Composition (40 ppm), achieved a lower corrosion rate than the Ref Composition. The further addition of a mercaptan (diethyl dithiophosphate) in composition B-2 also synergistically improved corrosion inhibition. Indeed, composition B-2 achieved roughly similar corrosion rates as composition A-2 and the Ref composition at a significantly lower dosage (5 ppm). Composition C-3 shows that the combination of an anionic surfactant with a different cationic surfactant, namely a fatty amine ethoxylate, can likewise significantly reduce the corrosion rate. Indeed, similarly to composition A-2, composition C-3, at a dosage (15 ppm) that was less than half of the dosage of the Ref composition (40 ppm), achieved a lower corrosion rate than the Ref composition over the duration after dosage.

Although some embodiments of the invention have been described in detail above, those skilled in the art will readily appreciate that many modifications are possible in the example embodiments without materially departing from the disclosed embodiments. Accordingly, all such modifications are intended to be included within the scope of this disclosure as defined in the following claims.

What is claimed is:

1. A method for inhibiting corrosion of a corrodible metal surface that contacts a water stream in a geothermal well system, the method comprising:
introducing into the water stream a corrosion inhibitor composition comprising: (i) a cationic surfactant including at least one of an imidazoline and a fatty amine ethoxylate, and (ii) an anionic surfactant.

2. The method according to claim 1, wherein the anionic surfactant is selected from the group consisting of an alkyl ether carboxylate, acyl sarcosine, an alkyl amphoacetate, and an alkyl sulfonate.

3. The method according to claim 1, wherein the anionic surfactant is selected from the group consisting of a linear or branched chain, alkoxylated C₆-C₃₆ alkyl ether carboxylate, oleoyl sarcosine, and sodium cocoamphoacetate.

4. The method according to claim 1, wherein the corrosion inhibitor composition further comprises a mercaptan.

5. The method according to claim 4, wherein the mercaptan is dialkyl dithiophosphate, mercaptoalkyl alcohol, or thioglycolic acid.

6. The method according to claim 1, wherein the water stream of the geothermal system is injected through an injection inlet to a subterranean production well, where the water stream is heated, and then the heated water stream is produced above ground through a production outlet.

7. The method according to claim 6, wherein the water stream is heated to a temperature in a range of 150° C. to 500° C.

8. The method according to claim 6, wherein steam from the heated water stream is delivered to a turbine to generate electric power.

9. The method according to claim 6, wherein the heated water stream is liquid water and/or water vapor.

10. The method according to claim 6, wherein the water stream produced by the production well has a calcium concentration in a range of 100 ppm to 40,000 ppm.

11. The method according to claim 6, wherein the corrosion inhibitor composition is introduced into the water stream before the water stream is injected through the injection inlet of the geothermal well system to the subterranean production well, or the corrosion inhibitor composition is introduced into the water stream through a capillary tube that extends towards the production well.

12. The method according to claim 1, wherein the corrosion inhibitor composition forms a protective film on the corrodible metal surface.

13. The method according to claim 1, wherein the corrosion inhibitor composition is stable at temperatures in a range of 150° C. to 500° C.

14. The method according to claim 1, wherein the corrosion inhibitor composition is introduced into the water stream in an amount in a range of from 0.1 ppm to 40 ppm.

15. The method according to claim 1, wherein the corrosion inhibitor composition is introduced into the water stream in an amount in a range of from 1 ppm to 30 ppm.
